(19) United States
(12) Patent Application Publication
(10) Pub. No.: US 2017/0119135 A1
(43) Pub. Date: May 4, 2017

(54) Frame for Portable Electronic Media Device

(71) Applicant: Alberto Somoano, Miramar, FL (US)

(72) Inventor: Alberto Somoano, Miramar, FL (US)

(21) Appl. No.: 14/927,067

(22) Filed: Oct. 29, 2015

(51) Int. Cl. A45F 5/00; F16M 13/02; F16B 1/00

(52) U.S. Cl. CPC A45F 5/00; F16B 1/00; F16M 13/02; F16B 2001/0035; A45F 2200/0508; A45F 2200/0516; A45F 2200/0525

(57) ABSTRACT

The present invention discloses a frame for a portable electronic media device so as to provide the stability to the portable electronic media device while capturing an image. The frame comprises three rods wherein the third rod is adjustable to accommodate the different sizes of portable electronic media device. At least two of three rods comprises a screw hole and a magnet wherein the screw hole is enabled to receive the screw of the external device such as tripod or stand and magnet is enabled to hold the external device firmly. The present invention provides unique proposition while capturing the image from the portable electronic media device.

### BACKGROUND

With the advancement of the embedded systems, the smart phones are replacing the traditional camera to capture pictures or for video recording purposes. Nowadays, smart phones offer extensive features to the user to add attributes to the capture picture or video such as change of color, background change, pixel size, dimensions of the picture or a cropping feature. The users are now adapted to the smart phones and has become the first preference to capture pictures or in recording videos. Moreover, people are nowadays excited to take selfies and share it with their friends. Users want to see themselves in the picture so they can enjoy the moment completely. Usually, they encounter a problem while holding the smart phone or taking the selfies. Usually, the user holds the smart phone with one hand and clicks on a button to capture the image. However, this process has many disadvantages. Many times, the smart phone gets dropped from the hand due to improper handling which results in unnecessary damage to the smart phone. Moreover, the user can only hold the smart phone at the arm length which usually does not capture the entire view of the surroundings. In this way, the captured selfies remain limited to the person's vicinity and hence does not capture the entire situation or surroundings. In addition to that, the user fails to hold the smart phone stable enough which affects the quality of the captured image. The camera of the smart phone needs to remain stable for few second to capture the image correctly. But the consistent small vibrations, due to blood pressure, vibrates our hand minutely which therefore becomes the reason of non-stability of the smart phones which taking the capture. These small vibrations in our hand fail to keep the smart phone stable enough so as to capture the picture accurately.

Hence, the present invention discloses a unique frame to overcome the above mentioned problems.

### FIELD OF THE INVENTION

The present invention is related to the frame to hold a portable electronic media device and more specifically, the three sided frame to hold the portable electronic media device.

### SUMMARY

The present invention discloses a frame for a portable electronic media device so as to provide the stability to the portable electronic media device while capturing an image. The frame comprises three rods wherein the third rod is adjustable to accommodate the different sizes of portable electronic media device. At least two of three rods comprises a screw hole and a magnet wherein the screw hole is enabled to receive the screw of the external device such as tripod or stand and magnet is enabled to hold the external device firmly. The present invention provides unique proposition while capturing the image from the portable electronic media device.

### BRIEF DESCRIPTION OF THE DRAWINGS

FIG. 1 illustrates an external device 202 and three rods 100, 102, 104 of the frame 200 coupled to each other.

FIG. 2 illustrates the second rod 102 in a folded state.

FIG. 3 illustrates the first rod 100 in a folded state.

FIG. 4 illustrates the third rod 104 in an extendable state with the usage of extendable rod 106.

FIG. 5 illustrates the portable electronic media device 204 adjusted with the frame 200.

### DETAILED DESCRIPTION OF THE DRAWINGS

Reference will now be made in detail to the exemplary embodiment(s) of the invention, examples of which are illustrated in the accompanying drawings. Whenever possible, the same reference numerals will be used throughout the drawings to refer to the same or like parts.

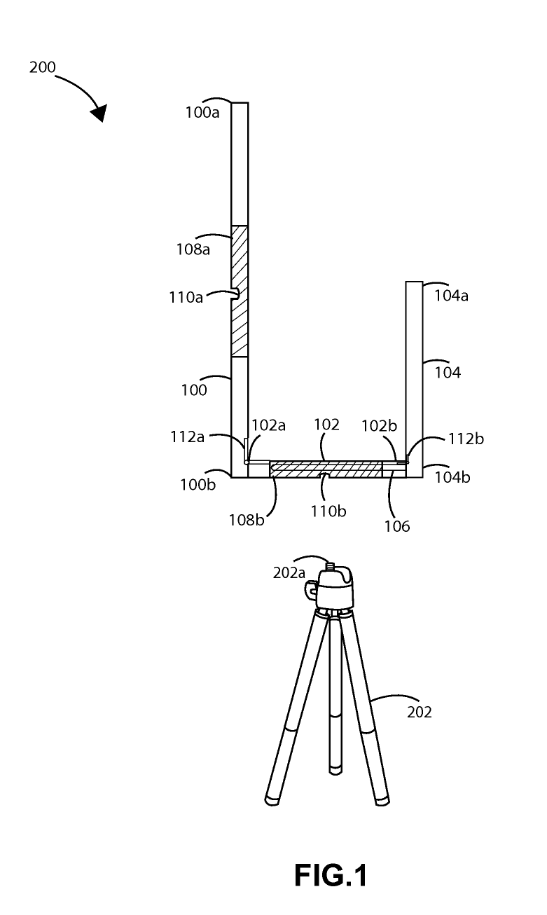

FIG. 1 illustrates an external device 202 and the three rod 100, 102, 104 of the frame 200 coupled to each other by a coupling unit 112a, 112b. The extendable rod 106 resides inside the second rod 102. The frame 200 comprises a first rod 100, a second rod 102 and third rod 104. The second end 100b of the first rod 100 is coupled with the first end 102a of the second rod 102 and the second end 102b of the second rod 102 is coupled with the second end 104b of the third rod 104. Further, the first rod 100 and the second rod 102 comprises a magnet 108a, 108b respectively and screw hole 110a, 110b respectively wherein the magnet 108a, 108b is enabled to hold the external device 202 firmly with the respective rods 100, 102, 104 of the frame 200 and either of the screw hole 110a, 110b is enabled to receive the screw 202a of the external device.

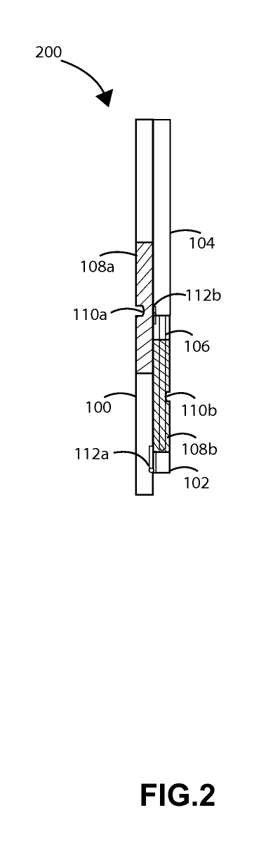

FIG. 2 illustrates the second rod 102 in a folded state. A coupling unit 112a, 112b is at least one of a hinge, a flange, adjustable lock. The coupling unit 112a provides coupling between the first end 102a of the second rod 102 and second end 100b of the first rod 100. Similarly the coupling unit 112b provides the coupling between the second end 102b of the second rod 102 and second end 104b of the third rod 104. The coupling unit 112b tends to adjust the second rod 102 and third rod 104 in an aligned position. Thereafter the coupling unit 112a tends to adjust the second rod 102 and third rod 104 to reside on the first rod 100. The second rod 102 and third rod 104 resides on the first rod 100 in a folded state.

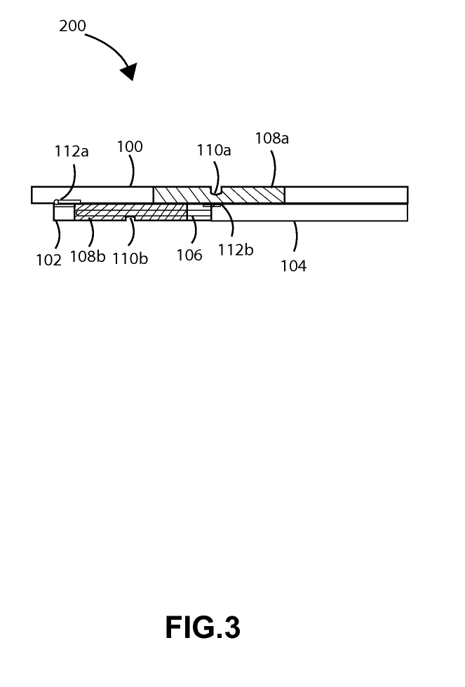

FIG. 3 illustrates the first rod 100 in a folded state. The coupling unit 112a provides coupling between the second end 102b of the second rod 102 and second end 104b of the third rod 104. The coupling unit 112b tends to adjust the second rod 102 and third rod 104 in an aligned position. Similarly the second end 100b of the first rod 100 is coupled with the first end 102a of the second rod 102. Thereafter the coupling unit 112a tends to adjust the first rod 100 to reside on the second rod 102 and third rod 104. The first rod 100 resides on the second rod 102 and third rod 104 in a folded state.

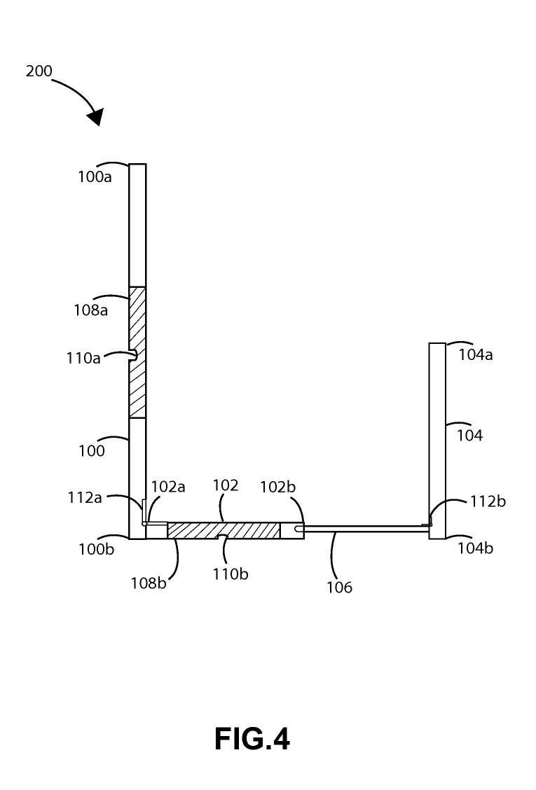

FIG. 4 illustrates the third rod 104 in an extendable state with the usage of extendable rod 106. The extendable rod 106 resides inside the second rod 102 and extended to increase a width of the frame 200 by actuating the third rod 104 in one direction. The one end of the extendable rod 106 coupled with second end 102b of the second rod 102 and second end of the extendable rod 106 is coupled with the coupling unit 112b. The extendable rod 106 coupled with the second end 102b of the third rod 104 is extended by actuating the third rod 104 in one direction. The width of the frame 200 is adjusted according to the size of the portable electronic media device 204.

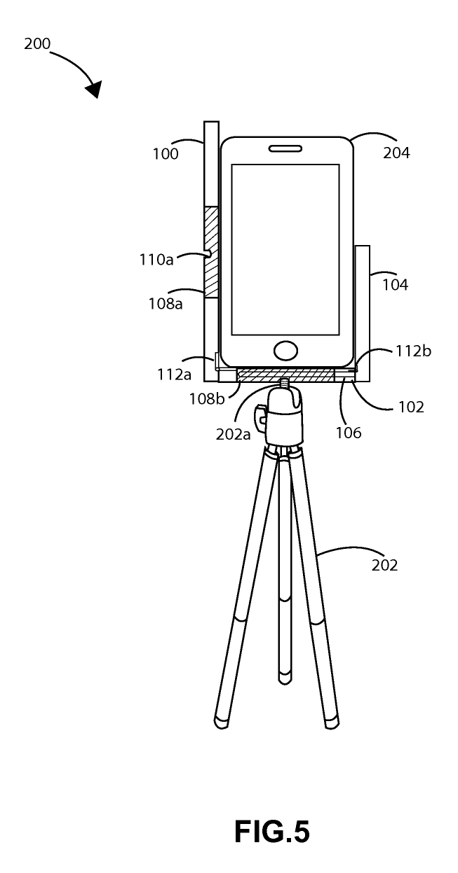

FIG. 5 is a preferred embodiment and illustrates the portable electronic media device 204 adjusted with the frame 200. The portable electronic media device 204 is at least one of smartphone, tablet, fablet, display screen, portable electronic device. The width of the frame 200 adjusted according to the size of the portable electronic media device 204. The extendable rod 106 resides inside the second rod 102 and extended to increase width of the frame 200. The extendable rod 106 coupled with the third rod 104 and extended by actuating the third rod 104 in one direction. The external device 202 is at least one of a tripod, easel and a stand. The screw 202a of the external device 202 inserted in the screw hole 110b of the second rod 102 wherein the magnet 108b is enabled to hold the external device 202 firmly with the respective rod 100, 102, 104 of the frame 200. The frame 200 is used to hold the portable electronic media device 204 of different width.

What is claimed is:

1. A frame for a portable electronic media device comprises:
a first rod, coupled with a second rod at an angle, and a third rod coupled with either the first rod or the second rod at an angle; and wherein the third rod is enabled to be adjusted according to the dimensions of portable electronic media device.

2. The frame of claim 1, wherein a second surface of the first rod comprises a screw opening so as to receive a screw unit to couple an external device with the first rod of the frame.

3. The frame of claim 1, wherein a second surface of the second rod comprises a screw opening so as to receive a screw unit to couple an external device with the second rod of the frame.

4. The frame of claim 1, wherein a second surface of the third rod comprises a screw opening so as to receive a screw unit to couple an external device with the third rod of the frame.

5. The frame of claim 1, wherein a second surface of the at least one of the first rod, the second rod and the third rod comprises a magnet so as to hold an external metal device with the respective rod strongly.

6. The frame of claim 1, wherein a first surface of the at least one of the first rod, the second rod and the third rod is enabled to receive the portable electronic media device.

7. The frame of claim 1, wherein at least one of the first rod and the second rod are enabled to fold itself.

8. The frame of claim 1, wherein the third rod is collapsible rod and is enabled to slide over either the first rod or the second rod so as to fit the portable electronic media device securely.

9. The frame of claim 1, wherein the angle between the first rod and the second rod is greater than 10 degree.

10. The frame of claim 1, wherein the angle between the third rod with either the first rod or the second rod is greater than 10 degree.

11. A frame for a portable electronic media device comprises:
a first rod, coupled with a second rod at an angle, and a third rod coupled with either the first rod or the second rod at an angle; wherein the third rod is enabled to be adjusted according to the dimensions of portable electronic media device; and wherein a second surface of the at least one of the first rod, the second rod and the third rod comprises at least one of a screw opening and a magnet so as to receive a screw unit in the screw hole to couple an external device with the respective rods of the frame and the magnet is enabled to hold the external metal device with the respective rod strongly.

12. The frame of claim 11, wherein a first surface of the at least one of the first rod, the second rod and the third rod is enabled to receive the portable electronic media device.

13. The frame of claim 11, wherein at least one of the first rod and the second rod are enabled to fold itself.

14. The frame of claim 11, wherein the third rod is collapsible rod and is enabled to slide over either the first rod or the second rod so as to fit the portable electronic media device securely.

15. The frame of claim 11, wherein the angle between the first rod and the second rod is greater than 10 degree.

16. The frame of claim 11, wherein the angle between the third rod with either the first side or the second side is greater than 10 degree.
